(19) United States
(12) Patent Application Publication
(10) Pub. No.: US 2005/0225034 A1
(43) Pub. Date: Oct. 13, 2005

(54) Modular mechanical seal

(76) Inventor: Alan James Roddis, Sheffield (GB)

Correspondence Address: MYERS BIGEL SIBLEY & SAJOVEC, PO BOX 37428, RALEIGH, NC, 27627, US

(21) Appl. No.: 10/501,589

(22) PCT Filed: Jan. 14, 2003
(86) PCT No.: PCT/GB03/00088

§ 371 Date: Apr. 18, 2005

(30) Foreign Application Priority Data
Jan. 14, 2002 (GB) 0200701.1

(51) Int. Cl. F16J 15/34

(52) U.S. Cl. 277/358

(57) ABSTRACT

A modular mechanical seal with a gland member, which is common to more than one generic seal format.

This invention relates to mechanical seals which are fitted to rotating equipment in virtually all types of industries.

A Mechanical seal comprises a “floating” component which is mounted axially movably around the rotary shaft of, for example, a pump and a “static” component which is axially fixed, typically being secured to a housing. The floating component has a flat annular end face, i.e. its seal face, directed towards a complementary seal face of the static component. The floating component is urged towards the static component to close the seal faces together to form a sliding face seal, usually by means of one or more spring members. In use, one of the floating and static components rotates; this component is therefore referred to as the rotary component. The other of the floating and static-components does not rotate and is referred to as the stationary component.

Those seals whose floating component is rotary are described as rotary seals. If the floating component is stationary, the seal is referred to as a stationary seal.

If the sliding seal between the Rotary and Stationary components are assembled and pre-set prior to despatch from the Mechanical seal manufacturing premises, the industry terminology for this is “cartridge seal”. If the Rotary and Stationary components are despatched individually (unassembled) from the Mechanical seal manufacturing premises, the industry terminology for this is “component seal”.

Mechanical seals are used in all types of industries to seal a variety of different process media and operating conditions. The general industry term which defines the area adjacent to the process media is “inboard”. The industry term which defines the area adjacent to the atmospheric side is “outboard”.

Like most industries, the mechanical seal industry is highly competitive.

As a result, mechanical seal manufacturers constantly seek methods of improving competitive advantage.

One such method is through component modularity. This can help a company to reduce inventory levels and gain component economies of scale through its production processes.

For most types mechanical seals, one of the most costly components in any given product assembly, is the seal gland. Typically, one seal gland is employed for each size of seal in both single and double seal formats. With over 30 standard seal sizes, in any given product range and at least two gland formats, the companies gland inventory costs can be considerable.

Furthermore gland production costs are high due to the number of manufacturing operations required to process a given gland.

A design which offers a modular seal gland for more than one seal format, while minimising the absolute number of manufacturing operations required to process said gland, is deemed to be advantageous.

It is deemed to be further advantageous if the minimum number of manufacturing operations are as simple as possible requiring only the most basic and effective material removal process. This reduces the cost to process the gland. Furthermore, it is advantageous if the seal assembly incorporates the minimum number of components, thereby helping further to reduce the cost of the assembly.

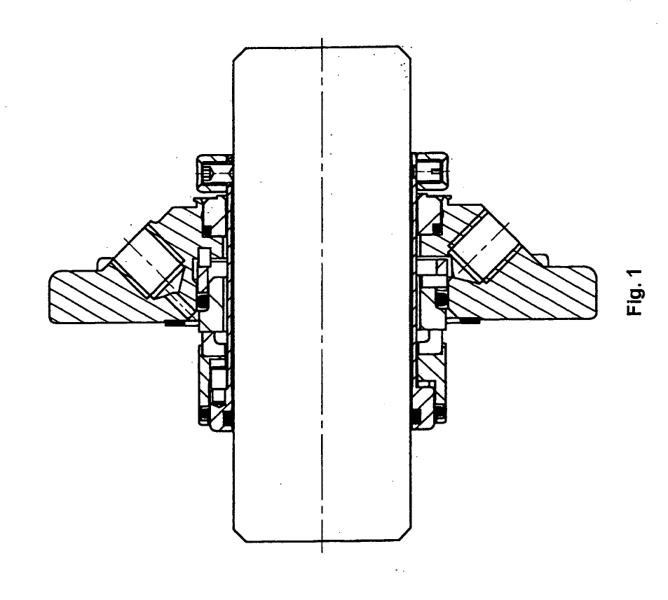

FIG. 1, shows a cross sectional view of a conventional prior art single cartridge mechanical seal.

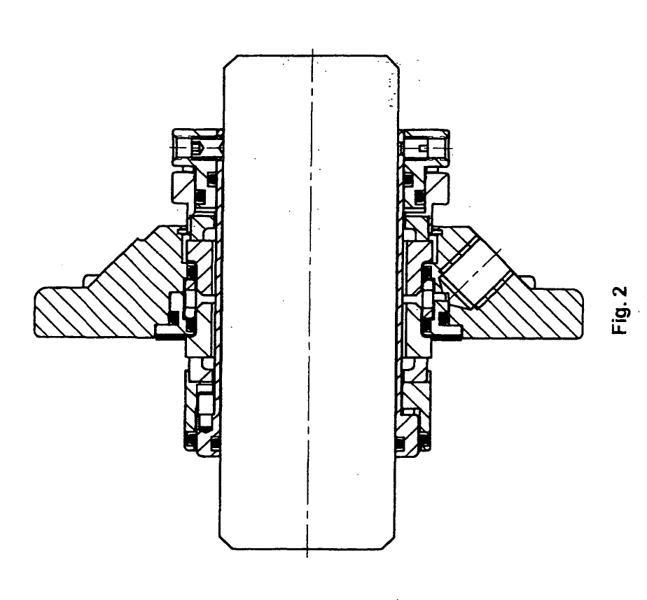

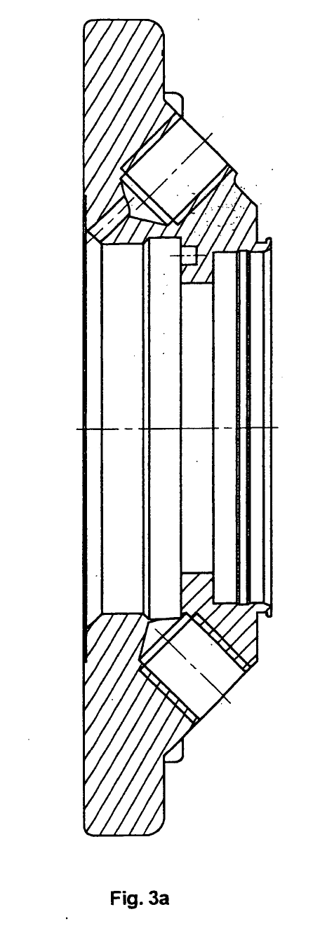

FIG. 2, shows a cross sectional view of a conventional prior art double cartridge mechanical seal.

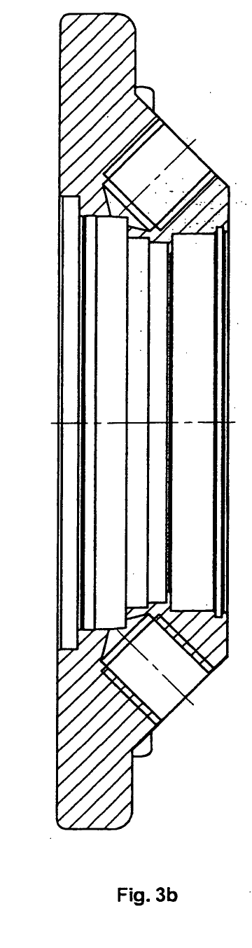

FIGS. 3a and 3b, corresponds to FIGS. 1 and 2 and illustrates the mandatory machining surfaces for the respective prior-art mechanical seal gland designs.

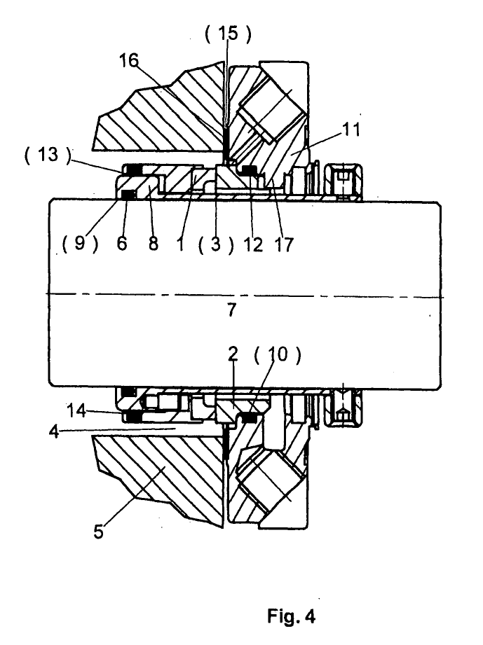

FIG. 4, shows a cross sectional view” of a single cartridge mechanical seal of the invention.

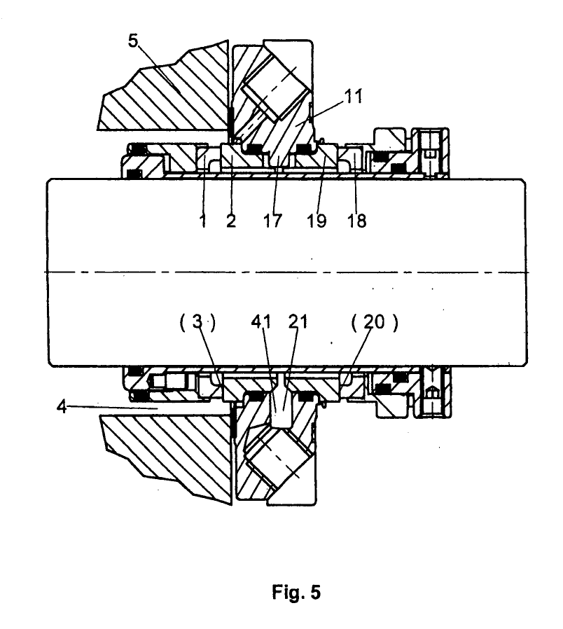

FIG. 5, shows a cross sectional view of a double cartridge mechanical seal of the invention.

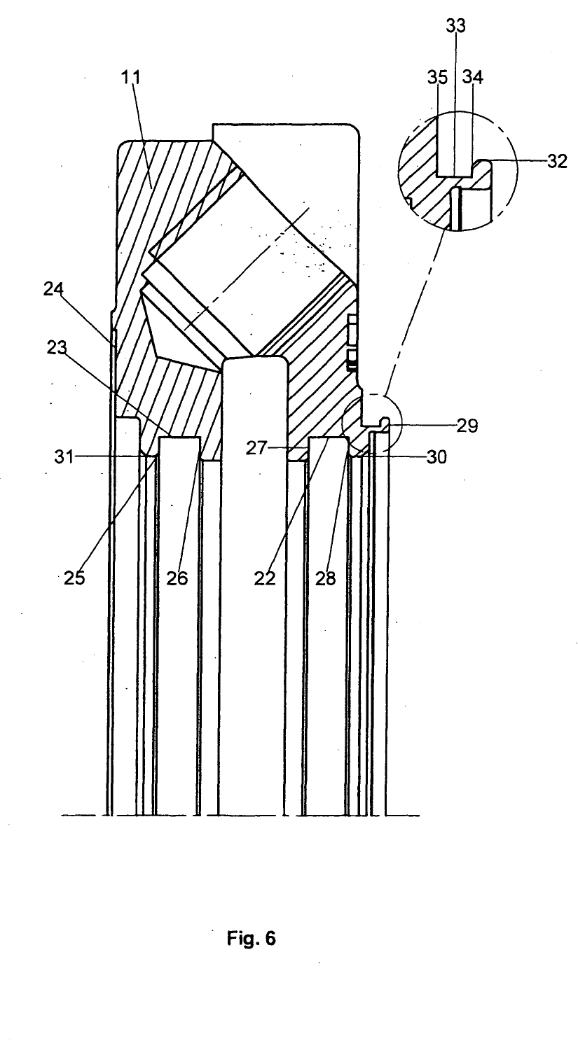

FIG. 6, shows a cross sectional view of the mechanical seal gland of the invention, illustrating the mandatory machining surfaces.

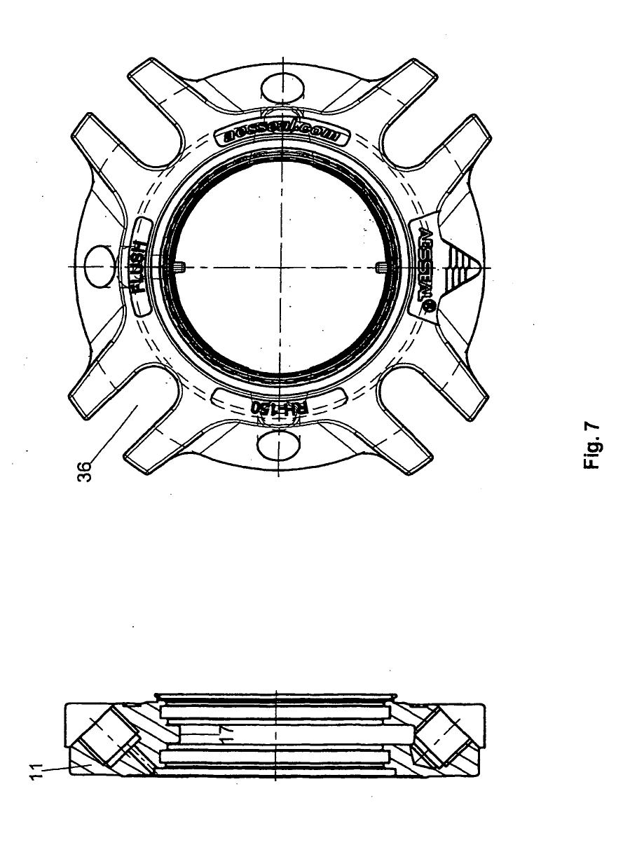

FIG. 7, shows a sectional and end view through the drive mechanism of the mechanical seal gland of the invention.

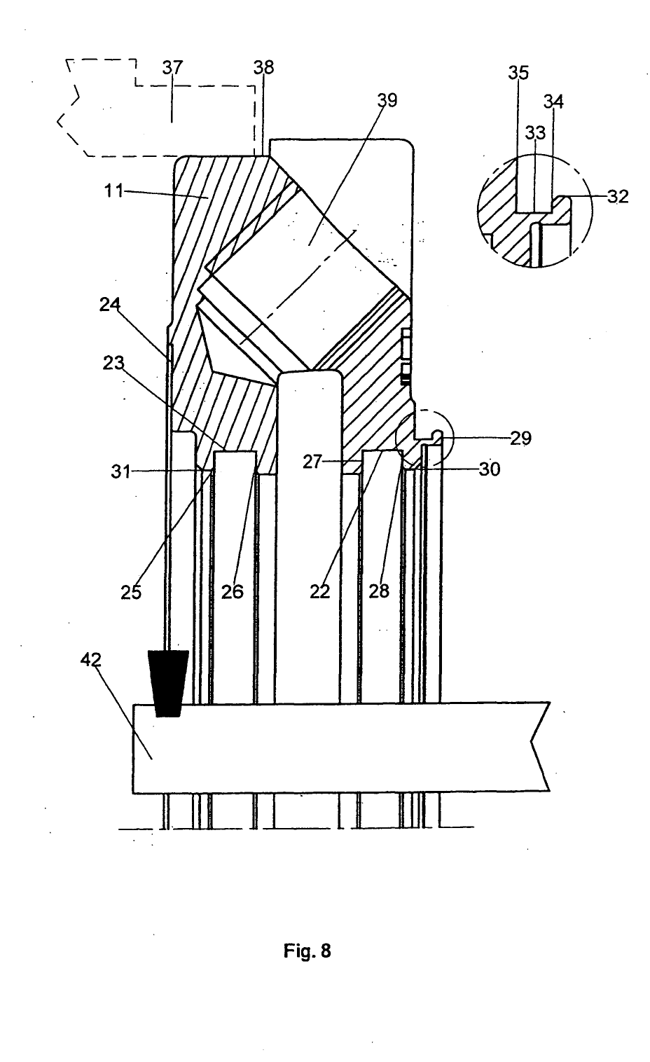

FIG. 8, shows a partial cross sectional view of the mechanical seal gland of the invention, illustrating the one operation machining process.

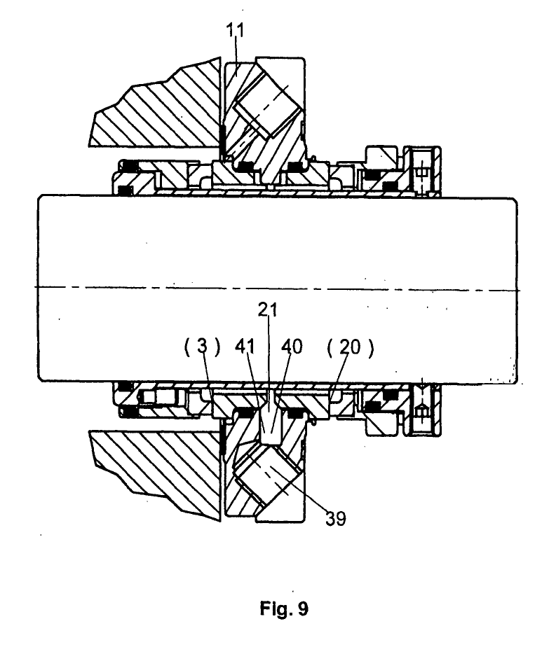

FIG. 9, shows a partial cross sectional view of the mechanical seal gland of the invention, illustrating at least one barrier media hole and internal gland recess.

An experienced person in the art of engineering production would recognise that the individual prior-art designs, shown in FIGS. 3a and 3b require a considerable number of machining operations and machine set-ups to achieve the mandatory machined surfaces.

From FIG. 4, of the invention, the rotary and axially floating seal face (1) is spring biased towards a static stationary seal face (2). The rotary seal face (1) is allowed to slide on the static seal face (2). The interface between the rotary seal face (1) and stationary seal face (2) forms sealing area (3). This sealing area (3) is the primary seal that prevents the process media (4) from escaping from the process chamber (5).

In addition to the sliding seal face (3), the process media (4) is sealed by a sleeve elastomer (6) in contact with the shaft (7) and sleeve (8). This has been termed the first secondary sealing area (9).

The second secondary sealing area (10) is formed between stationary seal face (2) and stationary gland (11) using elastomer (12).

The third secondary sealing area (13) is formed between the rotary seal face (1) and the sleeve (8) using elastomer (14).

The fourth secondary sealing area (15) is formed between the gland (11) and the process chamber (5) using gasket (16).

The four secondary sealing devices and the primary sliding sealing interface prevent the process media (4) from escaping.

The static seal face (2) is prevented from rotating by drive lug (17) in gland (11). By way of example only, this is shown as an integral part of gland (11), however this could be a separate component.

FIG. 5 shows the double seal version of the invention. Once again the rotary and axially floating seal face (1) is spring biased towards a static stationary seal face (2). The rotary seal face (1) is allowed to slide on the static seal face (2). The interface between the rotary seal face (1) and stationary seal face (2) forms sealing area (3). This sealing area (3) is the primary seal that prevents the process media (4) from escaping from the process chamber (5). The other secondary sealing points remain identical in concept to FIG. 4.

Towards the outboard side of the seal, the outboard rotary and axially floating seal face (18) is spring biased towards a static stationary seal face (19). The rotary seal face (18) is allowed to slide on the static seal face (19). The interface between the rotary seal face (18) and stationary seal face (19) forms sealing area (20). This sealing area (20) is the primary seal that prevents the barrier media (21) from escaping from the barrier chamber (41). The barrier media (21) is sealed at the inboard side of the assembly, by sealing area (3).

Once again the static outboard seal face (19) is prevented from rotating by drive lug (17) in gland (11). The rest of the parts in the assembly are common to most mechanical seals and will not be further discussed.

It will become apparent from FIG. 4 and FIG. 5, that a common, modular gland (11) is employed for both assemblies.

FIG. 6 shows the mandatory gland (11) machined surfaces, diameters (22 and 23) and faces (24, 25, 26, 27, 28 and 29). In addition, it is likely that diameters (30, 31, 32 and 33) and faces (34 and 35) will be also machined. It will be noted that said aforementioned surfaces perform sealing or equipment setting functions. These surfaces are therefore generally precision machined using an appropriate material removal process such as turning. Turning is a process generated by a lathe.

Turning is an accurate, efficient yet simple material removal process. Preferably, although not essential, the gland (11) design is such that no further material removal techniques, such as milling, is required. By way of example only, all the design features in gland (11) which would typically require milling, have been produced by a suitable process, such as casting, at the raw material production stage, prior to the component being machined.

To this effect, FIG. 7 illustrates the non-machined drive lug (17) and bolt location slots (36) in gland (11) which have been produced at the raw material production stage and are therefore not machined.

Furthermore, the gland (11) design is such that it could be manufactured in one operation, if required.

FIG. 8 illustrates the gland (11) held in a material removal machine. The material removal machine, or lathe, has a holding device, typically referred to as a chuck (37) which holds and supports the gland (11) during the machining process. Said gland (11) is located in the chuck (37) on gland diameter (38).

During gland (11) machining process, at least one material removal tool (42) approaches the gland (11) and machines surfaces (22 to 35), from side axially opposite the chuck (37). It will be noted that surface (24) is the machined using a material removal tool (42) approaching the gland (11) from a radially inwardly position and extending radially outwardly.

It will be appreciated by an experienced reader that the modular gland (11) of the invention, can be created in a singular machining set-up, without the need for subsequent re-holding and machining operations. Furthermore, all the machining processes could be performed using a relatively simple lathe.

From FIG. 9, Should a barrier media (21) insertion hole be required (39), the modular gland can still be machined by the aforementioned process with the use of a slightly more sophisticated 4-axis machine.

Typically, most types of equipment have an axial limit on the length of the mechanical seal assembly. In particular, double seals with at least one barrier media hole (39) should have a compact outboard length. From FIG. 9, it can be seen that a further feature of the gland (11) is that it is offered with at least one un-machined, internal recess (40). Said internal recess is preferable formed at the raw material stage.

This internal recess (40) allows the barrier media hole (39) to break into the barrier media chamber (41), thereby allowing barrier fluid (21) to lubricate and cool the sealing areas (3) and (20).

It is considered self evident to the experienced reader that the invention may be employed for both Rotary seals and Stationary seals, single, double or triple mechanical seals, whether designed in a cartridge or component seal format. It is also considered self evident that the invention may be used with metallic components as well as non-metallic components. Some types of equipment rotate the housing and have a stationary shaft. It is considered that the invention can be similarly applied to such designs.

1. A modular mechanical seal with a gland member, which is common to more than one generic seal format.

2. A mechanical seal according to claim 1, wherein a common gland member is employed for both single and double seal formats.

3. A mechanical seal according to claim 1, where the gland member is produced in at least one machining operation.

4. A mechanical seal according to claim 3, where the gland member includes a material holding diameter which allows the gland to be manufactured in at least one machining operation.

5. A mechanical seal according to claim 4, where the gland member includes a material holding diameter which is radially outwardly located allowing said gland to be completely machined from the end axially opposite the holding diameter.

6. A mechanical seal according to claim 1, where the gland member includes an internal un-machined recess adjacent to the barrier media communication hole.

7-8. (canceled)
